(19) United States
(12) Patent Application Publication
(10) Pub. No.: US 2014/0192416 A1
(43) Pub. Date: Jul. 10, 2014

(54) WINDOW MEMBER, METHOD OF MANUFACTURING THE SAME, AND DISPLAY DEVICE HAVING THE SAME

(71) Applicant: Chan Hee Wang, Yongin-City (KR)

(72) Inventor: Chan Hee Wang, Yongin-City (KR)

(21) Appl. No.: 13/942,658

(22) Filed: Jul. 15, 2013

(30) Foreign Application Priority Data
Jan. 8, 2013 (KR) 10-2013-0002172

(51) Int. Cl. G02B 27/00

(52) U.S. Cl. CPC G02B 27/00
USPC 359/609

(57) ABSTRACT

A window member includes a base substrate having a light transmitting area and a light blocking area surrounding the light transmitting area, a plurality of reflection patterns on the base substrate in the light blocking area and spaced from each other, and a light blocking layer covering the reflection patterns and configured to block light.

### CROSS-REFERENCE TO RELATED APPLICATION

This U.S. non-provisional patent application claims priority under 35 U.S.C. §119 to and the benefit of Korean Patent Application No. 10-2013-0002172, filed on Jan. 8, 2013, the entire contents of which are hereby incorporated by reference.

### BACKGROUND

1. Field

The present disclosure relates to a window member for a display device, a method of manufacturing the same, and a display device having the same.

2. Description of the Related Art

Various display devices, such as an organic light emitting display panel, a liquid crystal display panel, an electrophoretic display panel, an electrowetting display panel, etc., are used in various fields due to a rapid development of an information intensive society.

A display device generally includes a display panel, a case accommodating the display panel, and a window protecting an exposed surface of the display panel.

Meanwhile, the window affects an appearance of the display device and generally includes a light transmitting area in which an image is displayed and provided to a viewer and a light blocking area surrounding the light transmitting area. In the light blocking area, a white or black layer is disposed on a surface of the window facing the display panel, and thus light does not transmit through the light blocking area.

Since the light blocking area shows only the white or black color, the display device does not give an aesthetic sense to the viewer.

### SUMMARY

The present disclosure provides a window member for a display device capable of giving an aesthetic sense or appearance to a viewer, a method of manufacturing the window member, and a display device having the window member.

An embodiment of the present inventive concept provides a window member including a base substrate having a light transmitting area and a light blocking area surrounding the light transmitting area, a plurality of reflection patterns on the base substrate in the light blocking area and spaced from each other, and a light blocking layer covering the reflection patterns and configured to block light.

Each of the reflection patterns may include a plurality of layers having different refractive indices from each other.

Each of the reflection patterns may further include a first layer on the base substrate and configured to transmit light, and a second layer on the first layer and having a refractive index different from a refractive index of the first layer.

The refractive index of the first layer may be greater than the refractive index of the second layer.

Each of the first and second layers may have the refractive index in a range from about 1.3 to about 2.4, and a difference between the refractive index of the first layer and the refractive index of the second layer may be equal to or greater than about 0.1.

The first layer may have a thickness different from a thickness of the second layer in each of the reflection patterns.

Each of the reflection patterns may further include an etch stop layer on the second layer.

Each of the reflection patterns may have a single-layer structure including silver, aluminum, or aluminum alloy.

The reflection patterns may be color patterns that reflect lights having different colors from each other.

Another embodiment of the inventive concept provides a method of manufacturing a window member including sequentially forming a first layer and a second layer on a base substrate having a light transmitting area and a light blocking area surrounding the light transmitting area, the first and second layers having different refractive indices from each other, patterning the first and second layers to form a plurality of reflection patterns in the light blocking area, and forming a light blocking layer covering the reflection patterns and configured to block light.

The forming of the plurality of reflection patterns may include forming an etch stop layer on the second layer, patterning the etch stop layer to form a plurality of etch stop layer patterns in the light blocking area, and patterning the first and second layers corresponding to the etch stop layer patterns.

The refractive index of the first layer may be greater than the refractive index of the second layer.

Each of the first and second layers may have the refractive index in a range from about 1.3 to about 2.4, and a difference between the refractive index of the first layer and the refractive index of the second layer may be equal to or greater than about 0.1.

The etch stop layer may transmit light.

Yet another embodiment of the inventive concept provides a display device including a display panel and a window member having a light transmitting area and a light blocking area surrounding the light transmitting area. The window member includes a base substrate having the light transmitting area and the light blocking area surrounding the light transmitting area, a plurality of reflection patterns on a surface of the base substrate facing the display panel in the light blocking area, and a light blocking layer covering the reflection patterns and configured to block light.

According to the above, the window member for the display device includes the reflection patterns in the light blocking area to reflect light. Accordingly, the display device employing the window member may give the aesthetic sense or appearance to the viewer.

### BRIEF DESCRIPTION OF THE DRAWINGS

The above and other features and aspects of the present disclosure will become more apparent by reference to the following detailed description when considered in conjunction with the accompanying drawings wherein:

FIG. 1 is an exploded perspective view showing a display device including a window member according to an exemplary embodiment of the present disclosure;

FIG. 2 is a cross-sectional view showing the display device shown in FIG. 1;

FIG. 3 is a plan view showing the window member shown in FIG. 1;

FIG. 4 is a cross-sectional view taken along the line I-I′ of FIG. 3;

FIGS. 5 to 8 are cross-sectional views showing a method of manufacturing the window member shown in FIGS. 1 to 4;

FIG. 9 is a cross-sectional view showing a window member according to another exemplary embodiment of the present disclosure; and

FIG. 10 is a cross-sectional view showing a window member according to another exemplary embodiment of the present disclosure.

### DETAILED DESCRIPTION

It should be understood that when an element or layer is referred to as being “on”, “connected to”, or “coupled to” another element or layer, it can be directly on, connected, or coupled to the other element or layer, or intervening elements or layers may be present. In contrast, when an element is referred to as being “directly on,” “directly connected to,” or “directly coupled to” another element or layer, there are no intervening elements or layers present. Like numbers refer to like elements throughout. As used herein, the term “and/or” includes any and all combinations of one or more of the associated listed items.

It should be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present invention.

Spatially relative terms, such as “beneath”, “below”, “lower”, “above”, “upper”, and the like may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

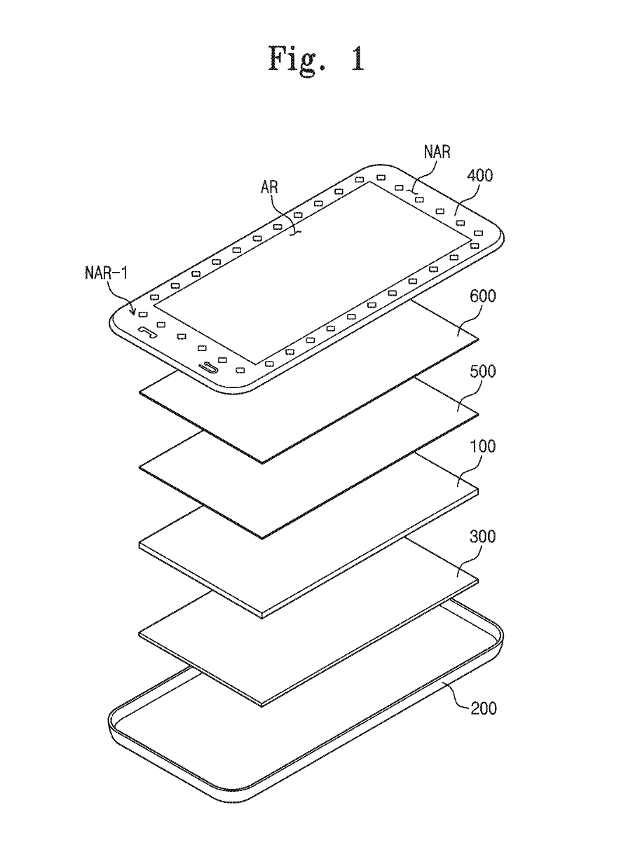

FIG. 1 is an exploded perspective view showing a display device including a window member according to an exemplary embodiment of the present disclosure and FIG. 2 is a cross-sectional view showing the display device shown in FIG. 1.

Referring to FIGS. 1 and 2, a display device includes a display panel 100, a housing 200 that accommodates the display panel 100, a window member 400 disposed (e.g., located or formed) on the display panel 100, a shock absorbing sheet 300 disposed between the display panel 100 and the housing 200, a polarizing member 500 disposed between the display panel 100 and the window member 400, and an adhesive layer 600 disposed between the window member 400 and the polarizing member 500.

The display panel 100 displays an image. The display panel 100 may be, but is not limited to, an organic light emitting display panel, which is a self-emissive display panel. In addition, the display panel 100 may be a non-self-emissive display panel, e.g., a liquid crystal display panel, an electrophoretic display panel, an electrowetting display panel, etc. In the case that the non-self-emissive display panel is used as the display panel 100, the display panel 100 further includes a backlight unit to supply light to the display panel 100.

When the organic light emitting display panel is used as the display panel 100, the display panel 100 includes two substrates and an organic light emitting device disposed (e.g., located or formed) between the two substrates. The organic light emitting device includes two electrodes and an organic layer disposed between the two electrodes. One of the electrodes is an anode electrode and the other one of the electrodes is a cathode electrode.

The housing 200 accommodates the display panel 100. FIG. 1 shows the housing 200 integrally formed as a single unitary and individual unit to provide a space in which the display panel 100 is accommodated, but the housing 200 may be configured to include two or more parts. In the present exemplary embodiment, the housing 200 integrally formed as a single unitary and individual unit will be described as a representative example.

In addition, the housing 200 may further accommodate a printed circuit board (not shown) electrically connected to the display panel 100 to drive the display panel 100. Further, the housing 200 may further accommodate a power supply, e.g., a battery, according to a kind of the display device.

The shock absorbing sheet 300 is disposed between the display panel 100 and the housing 200 to absorb external shocks applied to the display panel 100. Accordingly, the shock absorbing sheet 300 prevents or reduces the external shocks from being directly applied to the display panel 100.

The shock absorbing sheet 300 includes a shock absorbing film (not shown) that absorbs or reduces the external shocks and an adhesive (not shown) coated on at least one surface of the shock absorbing film. For instance, the adhesive may be coated on the surface of the shock absorbing film, and the shock absorbing sheet 300 is attached to the display panel 100 or the housing 200 by the adhesive. In addition, the shock absorbing film may include a rubber-foam layer having a thickness of about 300 micrometers.

The window member 400 is disposed (e.g., arranged or located) in a direction to which the light used to display the image on the display panel 100 (or, in the case of a self-emissive display, the direction in which the light emitted by the display panel 100) travels and is coupled to (e.g., joined with) the housing 200 to form an outer surface of the display device.

The window member 400 includes a light transmitting area AR through which the image displayed on the display panel 100 is transmitted and a light blocking area NAR disposed (e.g., located) adjacent to at least a portion of the light transmitting area AR. The image is not displayed in (e.g., not transmitted through) the light blocking area NAR. In addition, at least a portion of the light blocking area NAR may be used as an input icon area NAR-I. The input icon area NAR-I is activated when the display device is operated in a specific (e.g., predetermined) mode.

In addition, the window member 400 includes a base substrate 410, a light blocking layer 420 disposed (e.g., located) on the base substrate 410 in the light blocking area NAR, and a plurality of reflection patterns 430 disposed between the base substrate 410 and the light blocking layer 420. That is, the reflection patterns 430 are disposed on the surface of the base substrate 410 facing the display panel 100. The reflection patterns 430 reflect (e.g., are configured to reflect) light (e.g., a specific light) to the viewer. The reflection patterns 430 may reflect lights having the same color or lights having the different colors.

The polarizing member 500 prevents (e.g., is configured to prevent or reduces the degree of) degradation of the quality of the image displayed in the display panel 100 due to the reflection of light from an external source (referred to as external light). For example, the polarizing member 500 includes a polarizing film (not shown) having a polarizing axis in a specific (e.g., predetermined) direction and a retardation film (not shown) having a phase difference of about A/4. The polarizing member 500 circularly polarizes the external light to prevent the quality of the image displayed in the display panel 100 from being degraded due to the reflection of external light. However, the polarizing member 500 may be omitted in this or other embodiments.

The adhesive layer 600 couples (e.g., joins) the display panel 100 and the polarizing member 500. The adhesive layer 600 may be transparent to prevent brightness of the image displayed in the display panel 100 from being reduced. For instance, the adhesive layer 600 may include a transparent polymer resin with a viscosity, which is cured by the application of heat and pressure.

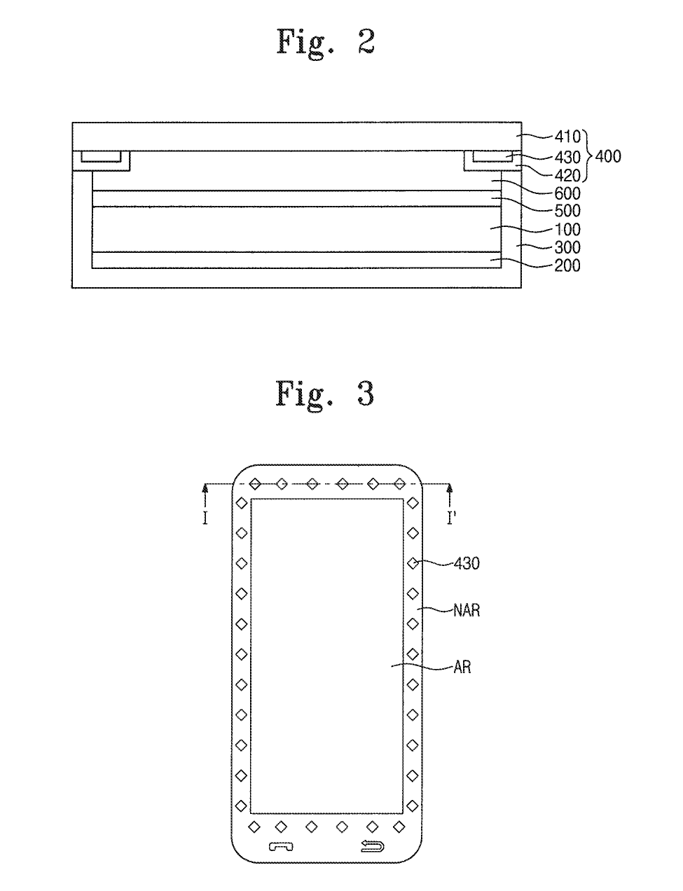

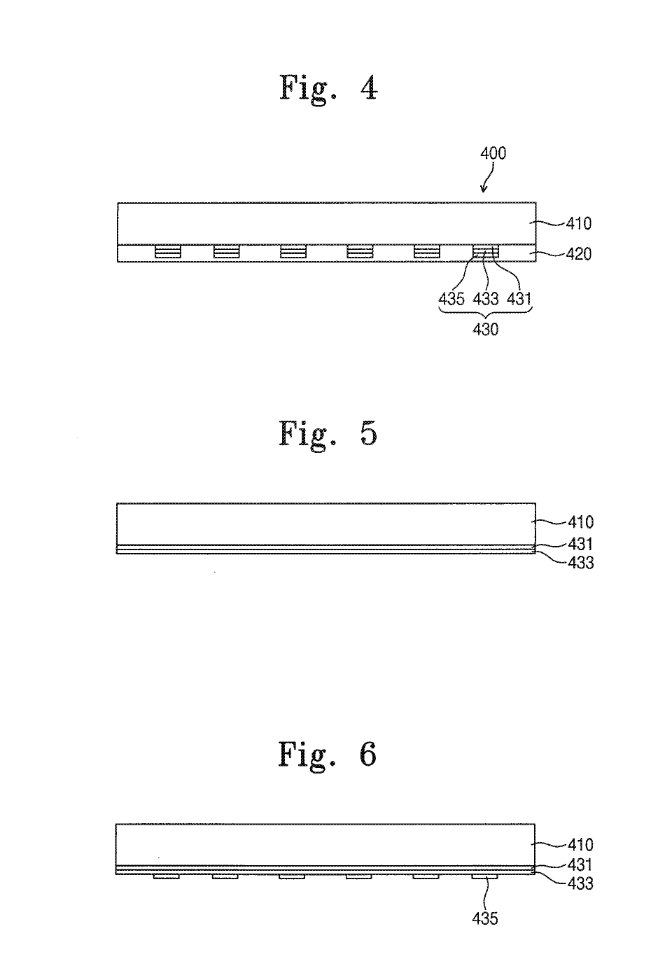

FIG. 3 is a plan view showing the window member shown in FIG. 1, and FIG. 4 is a cross-sectional view taken along the line I-I′ of FIG. 3.

Referring to FIGS. 3 and 4, the window member 400 includes the base substrate 410, the reflection patterns 430, and the light blocking layer 420.

The base substrate 410 may be a high strength plastic substrate or a high-strength, transparent glass substrate. In addition, the base substrate 410 includes the light transmitting area AR through which light transmits and the light blocking area NAR surrounding (or substantially surrounding) the light transmitting area AR. That is, the image displayed in the display panel 100 transmits through the light transmitting area AR.

The reflection patterns 430 reflect the external light (or a portion thereof) to give an aesthetic sense to the viewer. The reflection patterns 430 are disposed (e.g., located) on the surface of the base substrate 410 facing the display panel 100 in the light blocking area NAR and spaced (e.g., spaced apart) from each other.

Each of the reflection patterns 430 (e.g., each of the plurality of reflection patterns 430) includes a plurality of layers having refractive indices different from each other. As shown in FIG. 4, each reflection pattern 430 includes a first layer 431 disposed on the base substrate 410 which transmits light, and a second layer 433 disposed on the first layer 431 having a refractive index different from that of the first layer 431. The refractive index of the first layer 431 may be greater than the refractive index of the second layer 433. In detail, each of the first and second layers 431 and 433 has the refractive index in a range from about 1.3 to about 2.4, and a difference between the refractive index of the first layer 431 and the refractive index of the second layer 433 may be equal to or greater than about 0.1.

The first and second layers 431 and 433 include different materials, for instance, silicon oxide (SiO₂) and titanium oxide (TiO₂). For instance, the first layer 431 includes titanium oxide (TiO₂) having the refractive index greater than that of silicon oxide (SiO₂), and the second layer 433 includes silicon oxide (SiO₂) having the refractive index less (e.g., smaller) than that of the titanium oxide (TiO₂).

In the present exemplary embodiment, the reflection patterns 430 include the first layer 431 and the second layer 433, but they should not be limited thereto or thereby. For instance, the reflection patterns 430 may include plural (e.g., a plurality of) first layers and plural (e.g., a plurality of) second layers.

In addition, each reflection pattern 430 further includes an etch stop layer 435 disposed (e.g., located) on the second layer 433 which transmits light. The etch stop layer 435 serves (e.g., is configured to serve) as an etch mask for the first and second layers 431 and 433. Accordingly, the etch stop layer 435 is formed of a material having an etch selectivity with respect to (e.g., corresponding to) the first and second layers 431 and 433.

Further, the etch stop layer 435 may include a material having a refractive index different from those of the first and second layers 431 and 433. For instance, the etch stop layer 435 may include a transparent conductive oxide, e.g., indium tin oxide or indium zinc oxide.

The light blocking layer 420 is disposed (e.g., located) on the base substrate 410 in the light blocking area NAR to cover (or substantially cover) the reflection patterns 430. The light blocking area 420 includes a material that blocks light to prevent light from transmitting through the light blocking area NAR. In detail, the light blocking layer 420 may include a metal material with a low reflectivity, e.g., chromium (Cr), molybdenum (Mo), etc. In addition, the light blocking layer 420 may include a non-transparent inorganic insulating material, e.g., CrOx, MoOx, etc. Further, the light blocking layer 420 may include a non-transparent organic insulating material, e.g., a white resin, a black resin, etc.

FIGS. 5 to 8 are cross-sectional views showing a method of manufacturing the window member shown in FIGS. 1 to 4.

Referring to FIG. 5, the base substrate 410 is prepared. The base substrate 410 may be the high strength transparent plastic substrate or the high strength, transparent glass substrate. The base substrate 410 includes the light transmitting area AR to (e.g., configured to) transmit light and the light blocking area NAR surrounding the light transmitting area AR. That is, the image displayed in the display panel 100 transmits through the light transmitting area AR.

Then, the first layer 431 and the second layer 433, which have refractive indices different from each other, are sequentially formed on the base substrate 410. Here, the refractive index of the first layer 431 is greater than the refractive index of the second layer 433. The first and second layers 431 and 433 may include different materials, for instance, silicon oxide (SiO₂) and titanium oxide (TiO₂). For instance, the first layer 431 includes titanium oxide (TiO₂) having the refractive index greater than that of silicon oxide (SiO₂), and the second layer 433 includes silicon oxide (SiO₂) having the refractive index less (e.g., smaller) than that of the titanium oxide (TiO₂).

Referring to FIG. 6, the etch stop layer 435 is formed on the second layer 433 in the light blocking area NAR. The etch stop layer 435 includes the transparent conductive oxide having the etch selectivity with respect to the first and second layers 431 and 433. In addition, the etch stop layer 435 may be formed by (e.g., using) a printing method, e.g., an inkjet printing method.

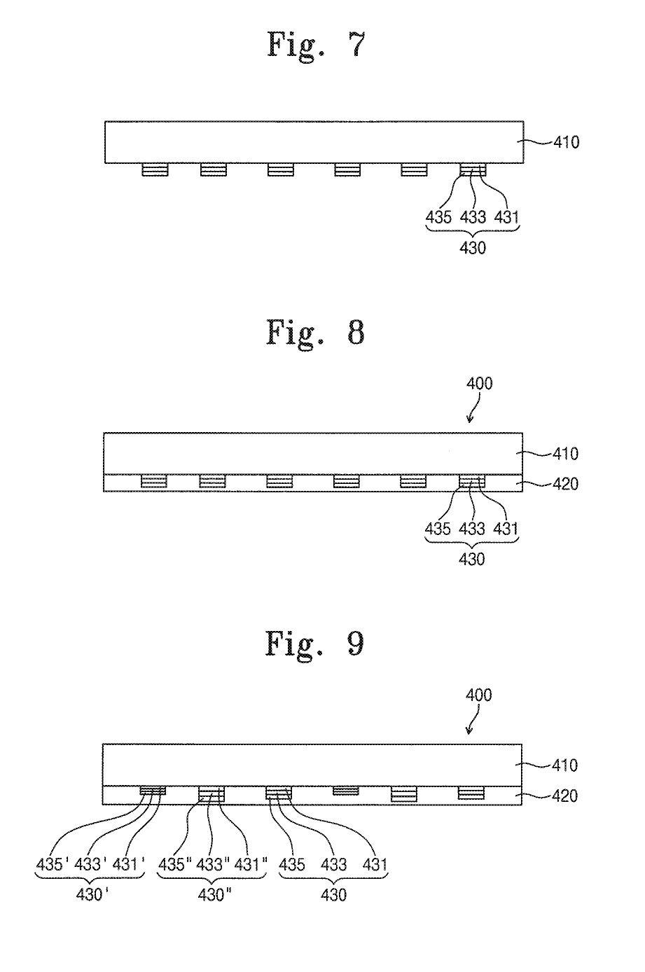

Referring to FIG. 7, after the etch stop layer 435 is formed, the first layer 431 and the second layer 433 are etched using the etch stop layer 435 as a mask, and thus the reflection patterns 430 are formed on the base substrate 410 in the light blocking area NAR and spaced (e.g., spaced apart) from each other. Thus, each reflection pattern 430 includes the first layer 431, the second layer 433, and the etch stop layer 435.

Referring to FIG. 8, when (e.g., after) the reflection patterns 430 are formed, the light blocking layer 420 is formed to cover (or substantially cover) the reflection patterns 430 and prevent light from transmitting through the light blocking area NAR. In detail, the light blocking layer 420 may include the metal material with the low reflectivity, e.g., chromium (Cr), molybdenum (Mo), etc. In addition, the light blocking layer 420 may include the non-transparent inorganic insulating material, e.g., CrOx, MoOx, etc. Further, the light blocking layer 420 may include the non-transparent organic insulating material, e.g., a white resin, a black resin, etc.

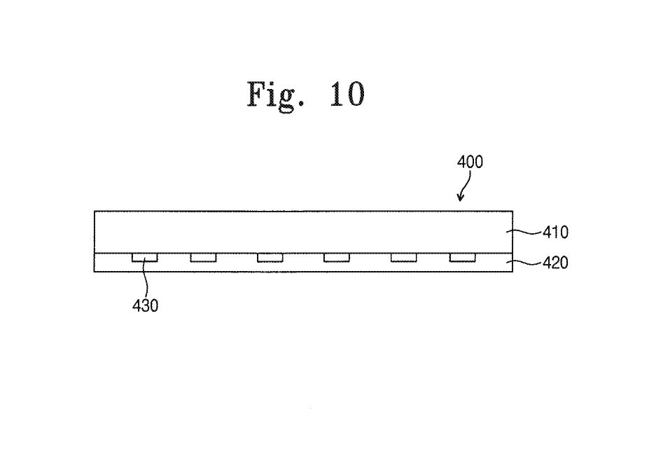

Hereinafter, window members according to another exemplary embodiment will be described in detail with reference to FIGS. 9 and 10. In FIGS. 9 and 10, the same reference numerals denote the same elements in FIGS. 1 to 8, and thus detailed descriptions of the same elements will be omitted.

FIG. 9 is a cross-sectional view showing a window member according to another exemplary embodiment of the present disclosure.

Referring to FIG. 9, a window member 400 includes a base substrate 410, reflection patterns 430, 430′, and 430″, and a light blocking layer 420. The reflection patterns 430, 430′, and 430″ reflect color lights different from each other.

The base substrate 410 includes a light transmitting area AR transmitting light and a light blocking area NAR surrounding the light transmitting area AR.

The reflection patterns 430, 430′, and 430″ are disposed (e.g., located) on the base substrate 410 in the light blocking area NAR and spaced (e.g., spaced apart) from each other. Each of the reflection patterns 430, 430′, and 430″ includes plural (e.g., a plurality of) layers having refractive indices different from each other. In detail, the reflection patterns 430, 430′, and 430″ include first layers 431, 431′, and 431″, respectively, which are disposed on the base substrate 410 and transmit the light, and second layers 433, 433′, and 433″ respectively disposed on the first layers 431, 431′, and 431″ and having refractive indices different from those of (e.g., corresponding to) the first layers 431, 431′, and 431″. The refractive indices of the first layers 431, 431′, and 431″ are greater than the refractive indices of the second layers 433, 433′, and 433″, respectively.

In the reflection patterns 430, 430′, and 430″, the first layers 431, 431′, and 431″ have a thickness different from that of the second layers 433, 433′, and 433″. In this case, the colors of the lights reflected from the reflection patterns 430, 430′, and 430″ may be different from each other.

The light blocking layer 420 is disposed on the base substrate 410 in the light blocking area NAR to cover (or substantially cover) the reflection patterns 430, 430′, and 430″.

FIG. 10 is a cross-sectional view showing a window member according to another exemplary embodiment of the present disclosure.

Referring to FIG. 10, a window member 400 includes a base substrate 410, reflection patterns 430, and a light blocking layer 420.

The base substrate 410 includes a light transmitting area AR transmitting light (e.g., configured to transmit light) and a light blocking area NAR surrounding (or substantially surrounding) the light transmitting area AR.

The reflection patterns 430 are disposed on the base substrate 410 in the light blocking area AR and spaced (e.g., spaced apart) from each other. The reflection patterns 430 reflect lights having the same color or lights having different colors.

In the case that the reflection patterns 430 reflect lights having the same color, each reflection pattern 430 has a single-layer structure of, for instance, silver (Ag), aluminum (Al), or aluminum alloy (Al alloy), which have a high reflectivity.

In addition, in the case that the reflection patterns 430 reflect lights having the different colors, the reflection patterns 430 may be color patterns disposed on the base substrate 410. For instance, a portion of the reflection patterns 430 may be a first color pattern that reflects a red color light, another portion of the reflection patterns 430 may be a second color pattern that reflects a green color light, and the other portion of the reflection patterns 430 may be a third color pattern that reflects a blue color light. In the present exemplary embodiment, the reflection patterns 430 reflect the red, green, and blue lights, but the colors of the lights reflected by the reflection patterns 430 should not be limited thereto or thereby.

The light blocking layer 420 is disposed on the base substrate 410 in the light blocking area NAR to cover (or substantially cover) the reflection patterns 430.

Although exemplary embodiments of the present invention have been described, it is understood that the present invention should not be limited to these exemplary embodiments, but various changes and modifications can be made by one of ordinary skill in the art within the spirit and scope of the present invention as hereinafter claimed and by their equivalents.

What is claimed is:

1. A window member comprising:
a base substrate having a light transmitting area and a light blocking area surrounding the light transmitting area;
a plurality of reflection patterns on the base substrate in the light blocking area and spaced from each other; and
a light blocking layer covering the reflection patterns and configured to block light.

2. The window member of claim 1, wherein each of the reflection patterns comprises a plurality of layers having different refractive indices from each other.

3. The window member of claim 2, wherein each of the reflection patterns further comprises:
a first layer on the base substrate and configured to transmit light; and
a second layer on the first layer and having a refractive index different from a refractive index of the first layer.

4. The window member of claim 3, wherein the refractive index of the first layer is greater than the refractive index of the second layer.

5. The window member of claim 4, wherein each of the first and second layers has the refractive index in a range from about 1.3 to about 2.4, and a difference between the refractive index of the first layer and the refractive index of the second layer is equal to or greater than about 0.1.

6. The window member of claim 3, wherein the first layer has a thickness different from a thickness of the second layer in each of the reflection pattern.

7. The window member of claim 3, wherein each of the reflection patterns further comprises an etch stop layer on the second layer.

8. The window member of claim 1, wherein each of the reflection patterns has a single-layer structure comprising silver, aluminum, or aluminum alloy.

9. The window member of claim 1, wherein the reflection patterns are color patterns that reflect lights having different colors from each other.

10. A method of manufacturing a window member, the method comprising:
sequentially forming a first layer and a second layer on a base substrate having a light transmitting area and a light blocking area surrounding the light transmitting area, the first and second layers having different refractive indices from each other;
patterning the first and second layers to form a plurality of reflection patterns in the light blocking area; and
forming a light blocking layer covering the reflection patterns and configured to block light.

11. The method of claim 10, wherein the forming of the plurality of reflection patterns comprises:
forming an etch stop layer on the second layer;
patterning the etch stop layer to form a plurality of etch stop layer patterns in the light blocking area; and
patterning the first and second layers corresponding to the etch stop layer patterns.

12. The method of claim 11, wherein the refractive index of the first layer is greater than the refractive index of the second layer.

13. The method of claim 12, wherein each of the first and second layers has the refractive index in a range from about 1.3 to about 2.4, and a difference between the refractive index of the first layer and the refractive index of the second layer is equal to or greater than about 0.1.

14. The method of claim 11, wherein the etch stop layer transmits light.

15. A display device comprising:
a display panel; and
a window member having a light transmitting area and a light blocking area surrounding the light transmitting area, the window member comprising:
a base substrate having the light transmitting area and the light blocking area surrounding the light transmitting area;
a plurality of reflection patterns formed on a surface of the base substrate facing the display panel in the light blocking area; and
a light blocking layer covering the reflection patterns and configured to block light.

16. The display device of claim 15, wherein each of the reflection patterns comprises a plurality of layers having different refractive indices from each other.

17. The display device of claim 16, wherein each of the reflection patterns further comprises:
a first layer on the base substrate; and
a second layer on the first layer and having a refractive index different from a refractive index of the first layer.

18. The display device of claim 17, wherein each of the reflection patterns further comprises an etch stop layer on the second layer.

19. The display device of claim 15, wherein each of the reflection patterns has a single-layer structure comprising silver, aluminum, or aluminum alloy.

20. The display device of claim 15, wherein the reflection patterns are color patterns that reflect lights having different colors from each other.
